(19) United States
(12) Patent Application Publication
(10) Pub. No.: US 2013/0179246 A1
(43) Pub. Date: Jul. 11, 2013

(54) PROVIDING TARGETED OFFERS BASED ON AGGREGATE DEMAND AND AGGREGATE SUPPLY

(71) Applicant: Erik Stephen Ross, Charlotte, NC (US)

(72) Inventor: Erik Stephen Ross, Charlotte, NC (US)

(73) Assignee: BANK OF AMERICA CORPORATION, Charlotte, NC (US)

(21) Appl. No.: 13/346,362

(22) Filed: Jan. 9, 2012

(51) Int. Cl. G06Q 30/02

(52) U.S. Cl. 705/14.24

(57) ABSTRACT

Embodiments of the invention are directed to methods, systems, apparatus and computer program products for collecting location data, wherein the location data comprises information related to a physical location of a user, retrieving, based at least in part on the collected location data, aggregate data related to the product, the aggregate data comprising at least one of aggregate demand data or aggregate supply data, identifying at least one offer related to the product based at least in part on the collected location data and the retrieved aggregate data; and communicating the offer to the user.

### FIELD

In general, embodiments of the invention relate to methods, systems, apparatus and computer program products for communicating offers to users based on location data of the user and aggregate data such as aggregate demand and/or aggregate supply data related to a product.

### BACKGROUND

Oftentimes, merchants make offers related to a product to users based on the user's known place of residence or to users who reside within the geographic area of the merchant. “Product” refers to goods and/or services as used herein. However, such offers are ineffective to attract potential users who are only temporarily in an area, such as business travelers or individuals on vacation. Further, such offers typically do not take into account demand or supply of a product.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

According to embodiments of the invention, a method for communicating at least one offer for a product offered by a merchant includes collecting location data, wherein the location data comprises information related to a physical location of a user, retrieving, based at least in part on the collected location data, aggregate data related to the product, the aggregate data comprising at least one of aggregate demand data or aggregate supply data, identifying at least one offer related to the product based at least in part on the collected location data and the retrieved aggregate data, and communicating the offer to the user.

In some embodiments, the method also includes collecting user data, wherein the user data comprises information about the user and identifying one or more offers that relate to the product is further based at least in part on the user data. In some such embodiments, the user data is collected from at least one of transactional data, biographical data, social network data or publicly available data.

In some embodiments, the location data is collected from at least one of global positioning data, transaction data, mobile device data, social networking data or search data. In some embodiments, the offer is selected from selected from discounts for goods or services offered by the merchant, discounts for goods or services offered by other merchants, access to goods or services otherwise unavailable to the user, or reductions in fees.

In some embodiments, the method also includes receiving information from the user relative to an intended route of travel, determining a projection of the user's likely route of travel, based in part on the information received from the user, and communicating alternative offers to the user based on the projection of the user's likely route of travel. In some embodiments, the method also includes receiving information from the user related to the communicated offer, identifying at least one alternate offer that relates to the user, based at least in part on the information from the user, and communicating at least one alternate offer to the user.

In some embodiments, the aggregate data comprises aggregate demand data related to an aggregate demand of the product. In some such embodiments, the aggregate demand data comprises data indicating a demand for the product across a predetermined geographic territory. In other such embodiments, the aggregate demand data comprises data indicating a demand for the product higher than a predetermined threshold, and wherein identifying an offer for the product is based at least in part on the demand for the product being higher than the predetermined threshold. In yet other such embodiments, the aggregate demand data comprises data indicating a demand for the product lower than a predetermined threshold, and wherein identifying an offer for the product is based at least in part on the demand for the product being lower than the predetermined threshold.

In some embodiments, the aggregate data comprises aggregate supply data related to an aggregate supply of the product. In some such embodiments, the aggregate supply data comprises data indicating a supply of the product across a predetermined geographic territory. In other such embodiments, the aggregate supply data comprises data indicating a supply of the product higher than a predetermined threshold, and wherein identifying an offer for the product is based at least in part on the supply of the product being higher than the predetermined threshold. In yet other such embodiments, the aggregate supply data comprises data indicating a supply of the product lower than a predetermined threshold, and wherein identifying an offer for the product is based at least in part on the supply for the product being lower than the predetermined threshold.

According to embodiments of the invention, an apparatus includes a computing platform comprising a memory and at least one processor operatively connected with the memory, wherein the processor is configured to collect location data, wherein the location data comprises information related to a physical location of a user, retrieve, based at least in part on the collected location data, aggregate data related to the product, the aggregate data comprising at least one of aggregate demand data or aggregate supply data, identify at least one offer related to the product based at least in part on the collected location data and the retrieved aggregate data; and communicate the offer to the user.

In some embodiments, the processor is further configured to collect user data, wherein the user data comprises information about the user and identify one or more offers that relate to the product is further based at least in part on the user data. In some embodiments, the location data is collected from at least one of global positioning data, transaction data, mobile device data, social networking data or search data. In other such embodiments, the user data is collected from at least one of transactional data, biographical data, social network data or publicly available data.

In some embodiments, the offer is selected from discounts for goods or services offered by the merchant, discounts for goods or services offered by at least one other merchant, access to goods or services otherwise unavailable to the user, or at least one reduction in fees. In some embodiments, the processor is further configured to receive information from the user relative to an intended route of travel, determine a projection of the user's likely route of travel, based in part on the information received from the user, and communicate alternative offers to the user based on the projection of the user's likely route of travel

In some embodiments, the processor is further configured to receive information from the user related to the communicated offer, identify at least one alternate offer that relates to the user, based at least in part on the information from the user, and communicate at least one alternate offer to the user. In some embodiments, the aggregate data comprises aggregate demand data related to an aggregate demand of the product. In some such embodiments, the aggregate demand data comprises data indicating a demand for the product across a predetermined geographic territory. In other such embodiments, the aggregate demand data comprises data indicating a demand for the product higher than a predetermined threshold, and wherein identifying an offer for the product is based at least in part on the demand for the product being higher than the predetermined threshold. In yet other embodiments, the aggregate demand data comprises data indicating a demand for the product lower than a predetermined threshold, and wherein identifying an offer for the product is based at least in part on the demand for the product being lower than the predetermined threshold.

In some embodiments, the aggregate data comprises aggregate supply data related to an aggregate supply of the product. In some such embodiments, the aggregate supply data comprises data indicating a supply of the product across a predetermined geographic territory. In other such embodiments, the aggregate supply data comprises data indicating a supply of the product higher than a predetermined threshold, and wherein identifying an offer for the product is based at least in part on the supply of the product being higher than the predetermined threshold. In yet other such embodiments, the aggregate supply data comprises data indicating a supply of the product lower than a predetermined threshold, and wherein identifying an offer for the product is based at least in part on the supply for the product being lower than the predetermined threshold.

According to embodiments of the invention, a computer program product has a non-transitory computer-readable medium with computer-executable instructions stored thereon. The computer-executable instructions include instructions to collect location data, wherein the location data comprises information related to a physical location of a user, retrieve, based at least in part on the collected location data, aggregate data related to the product, the aggregate data comprising at least one of aggregate demand data or aggregate supply data, identify at least one offer related to the product based at least in part on the collected location data and the retrieved aggregate data, and communicate the offer to the user.

In some embodiments, the instructions further comprise instructions to collect user data, wherein the user data comprises information about the user, and identify one or more offers that relate to the product is further based at least in part on the user data. In some such embodiments, the user data is collected from at least one of transactional data, biographical data, social network data or publicly available data.

In some embodiments, the location data is collected from at least one of global positioning data, transaction data, mobile device data, social networking data or search data. In some embodiments, the offer is selected from discounts for goods or services offered by the merchant, discounts for goods or services offered by at least one other merchant, access to goods or services otherwise unavailable to the user, or at least one reduction in fees. In some embodiments, the instructions also include instructions to receive information from the user relative to an intended route of travel, determine a projection of the user's likely route of travel, based in part on the information received from the user, and communicate alternative offers to the user based on the projection of the user's likely route of travel.

In some embodiments, the instructions further comprise instructions to receive information from the user related to the communicated offer, identify at least one alternate offer that relates to the user, based at least in part on the information from the user, and communicate at least one alternate offer to the user.

In some embodiments, the aggregate data comprises aggregate demand data related to an aggregate demand of the product. In some embodiments, the aggregate demand data comprises data indicating a demand for the product across a predetermined geographic territory. In some embodiments, the aggregate demand data comprises data indicating a demand for the product higher than a predetermined threshold, and wherein identifying an offer for the product is based at least in part on the demand for the product being higher than the predetermined threshold. In some embodiments, the aggregate demand data comprises data indicating a demand for the product lower than a predetermined threshold, and wherein identifying an offer for the product is based at least in part on the demand for the product being lower than the predetermined threshold.

In some embodiments, the aggregate data comprises aggregate supply data related to an aggregate supply of the product. In some embodiments, the aggregate supply data comprises data indicating a supply of the product across a predetermined geographic territory. In some embodiments, the aggregate supply data comprises data indicating a supply of the product higher than a predetermined threshold, and wherein identifying an offer for the product is based at least in part on the supply of the product being higher than the predetermined threshold. In some embodiments, the aggregate supply data comprises data indicating a supply of the product lower than a predetermined threshold, and wherein identifying an offer for the product is based at least in part on the supply for the product being lower than the predetermined threshold.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a flow diagram illustrating a process flow for communicating offers for goods and services, in accordance with embodiments of the invention;

FIG. 2 provides a flow diagram illustrating a process flow for collecting location data of the customer, in accordance with embodiments of the invention;

FIG. 3A provides a mixed block and flow diagram illustrating a process flow for communicating offers for goods and services, in accordance with embodiments of the invention;

FIG. 3B provides a mixed block and flow diagram illustrating a process flow for communicating offers for goods and services, in accordance with embodiments of the invention;

FIG. 4 provides a flow diagram illustrating a process flow for collecting user data and identifying offers for goods and services, in accordance with embodiments of the invention; and

FIG. 5 provides a block diagram illustrating technical components of a system for communicating offers for goods and services, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Although embodiments of the present invention described herein are generally described as involving a merchant, it will be understood that the merchant may involve one or more persons, organizations, businesses, institutions and/or other entities such as financial institutions, services providers etc. that implement one or more portions of one or more of the embodiments described and/or contemplated herein.

The embodiments described herein may refer to the use of a transaction, transaction event or point of transaction event to trigger the steps, functions, routines etc. described herein. In various embodiments, occurrence of a transaction triggers the sending of information such as offers and the like. Unless specifically limited by the context, a “transaction”, “transaction event” or “point of transaction event” refers to any communication between the user and the merchant, e.g. financial institution, or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

As used herein, a “user device” or “mobile device” may be a point-of-transaction device as discussed, or may otherwise be a device carried by a user configured to communicate across a network such as a cellular network, wireless fidelity network or otherwise. As used here a “user” refers to a previous customer or a non-customer of one or more merchants or entities associated with one or more merchants.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

Thus, methods, systems, apparatus and computer program products are described herein for collecting location data, wherein the location data comprises information related to a physical location of a user, retrieving, based at least in part on the collected location data, aggregate data related to the product, the aggregate data comprising at least one of aggregate demand data or aggregate supply data, identifying at least one offer related to the product based at least in part on the collected location data and the retrieved aggregate data; and communicating the offer to the user.

In various embodiments, the invention determines offers to be communicated to a user based on location data, and possibly data related to the user. In these embodiments, the invention communicates aggregate data, such as aggregate demand data and/or aggregate supply data to the user so that the user may consider the aggregate data in making a purchasing decision. Thus, in some such embodiments, the aggregate data is only communicated to the user for the user's consideration and is not taken into account when determining which offers to send a user.

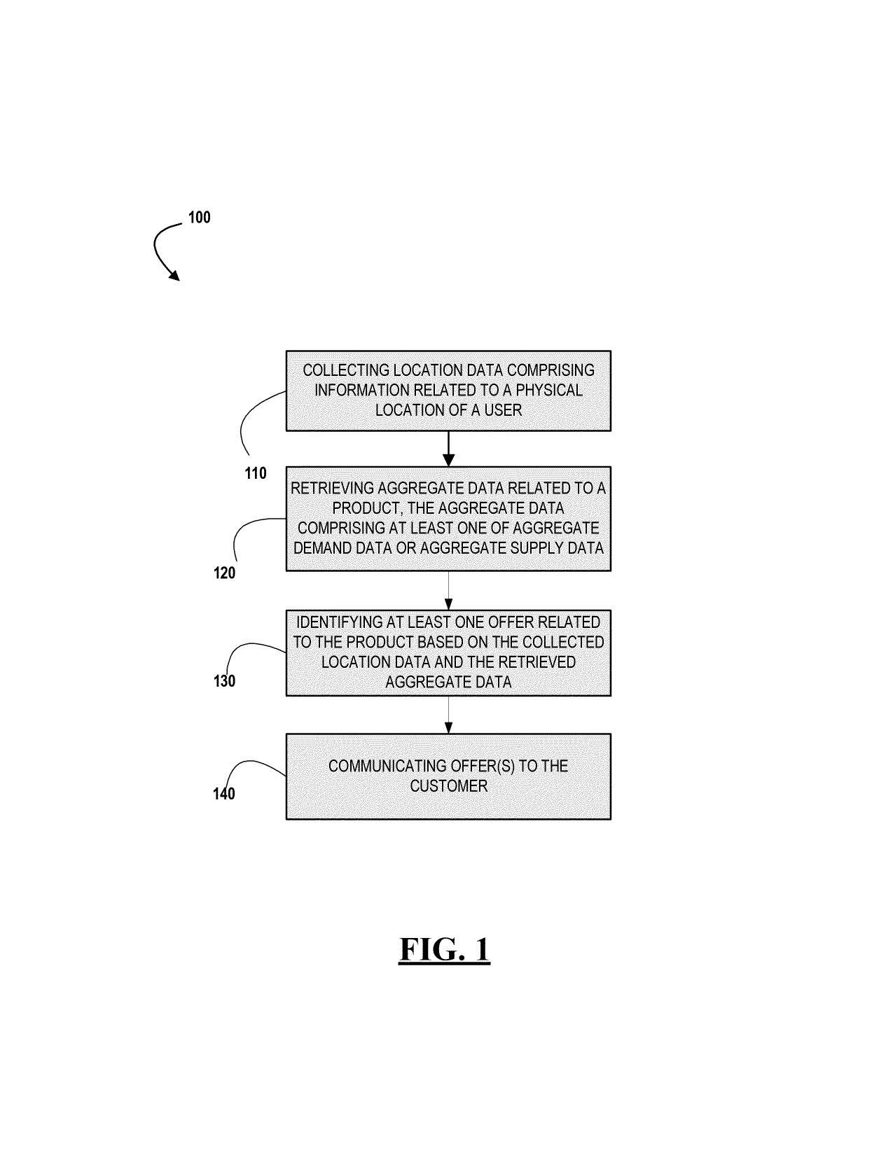

FIG. 1 illustrates a process flow 100 for communicating offers for a product, such as an offer for goods and/or services, in accordance with embodiments of the present invention. As represented by block 110, the first step is collecting location data including information related to a physical location of a user. In some embodiments, the physical location of the user is determined based on the physical location of a mobile device carried by the user. In some such embodiments, the location data is collected from global positioning system data of the mobile device of the user. In other embodiments, the location data is collected from wireless network location data. For example, a user connects to a wireless hotspot, and the location of the mobile device may be determined based on identification of the wireless network to which the mobile is connected.

As represented by block 120, the next step is retrieving aggregate data related to a product. The aggregate data, in various embodiments, includes aggregate demand data and in other embodiments, includes aggregate supply data. In some embodiments, the aggregate data includes both aggregate demand data and aggregate supply data. The aggregate data, in various embodiments, may be collected based on a particular geographic region. For example, the aggregate data may be collected for a particular product for a geographic region limited by municipal boundaries, such as the boundaries of a county, state, country, city, town or the like. In some embodiments, the geographic boundary is a predetermined distance away from the mobile device, such as, for example, five (5) miles away from the mobile device.

In some embodiments, the aggregate data is collected based not only on a particular product but also for replacements for the particular product. For example, for a Product 1 the collected aggregate data may include data regarding the aggregate demand and/or aggregate supply for Product 1 in addition to Products 2 and 3, which are potential replacements for Product 1.

The aggregate demand data, for example, may be related to the number of units of a product that have been sold for a particular time period in a particular geographic region. For example, the number of units of Product 1 sold over the last year in a particular geographic region. The aggregate demand data may be related to a quantified level of demand for the product at a particular time in the past or at the present time or as close to the present time as possible. For example, the quantified level of demand may be based on surveys of potential and/or actual customers and/or projections of the demand for the product based on other data. For example, a projection for the aggregate demand for a product may be based on actual numbers of the product that were purchased previously in a similarly situated time period and/or in a similar, such as the number of the product that were purchased the previous Saturday in the same geographic region where the mobile device is located.

In some embodiments where the aggregate data includes aggregate supply data, the aggregate supply data may be collected based on the supply of a product in a specific geographic region or worldwide. In some embodiments, the aggregate supply data may be related to the product as well as one or more potential replacement products. The aggregate supply data may be collected based on the number of units of a product and/or the product's potential replacement products that are in production as well as those units that are already on the market.

The next step, as represented by block 130, is identifying at least one offer related to the product based on the collected location data and the retrieved aggregate data. The offer(s), in various embodiments, may be identified based on the mobile device being in a specific geographic region where a particular product is offered for sale. If the aggregate demand or aggregate supply falls below or rises above a predetermined threshold, then an offer may be extended to a user. Furthermore, aggregate data may be provided to the user, and in some embodiments, the aggregate data may be provided in conjunction with an offer for the product, such as an offer to purchase the product at a discount. The aggregate data, for example, may indicate that Product 1 has an average demand of 10 units per day in the neighborhood where the mobile device is currently located. Furthermore, the aggregate data may indicate that the supply of Product 1 is currently 20 units within the neighborhood that the mobile device is currently located.

The aggregate data may also include an indication of micro-data including micro-demand and/or micro-supply of the product, such as the demand and/or supply of Product 1 at one specific merchant. For example, Merchant 1 may have three (3) units of Product 1 and typically sells one (1) unit of Product 1 per day. In conjunction with presentation of such micro-data, an offer for purchasing Product 1 at a discount or other incentive may be presented to the user.

Similarly, the aggregate data may also include macro-data including macro-demand and/or macro-supply of the product, such as the demand and/or supply of Product 1 within a larger geographic region, such as a state, country, or the entire world. For example, in some embodiments, aggregate data may be provided to a user regarding a product within a reasonable driving distance of the current location of the mobile device. In addition, in some embodiments, micro-data may be provided to the user regarding the product at the two closest merchants offering the product for sale. Further, macro-data may be provided to the user regarding the product at all merchants in the country in which the mobile device is located regarding the product. In this regard, the user may determine whether the user desires to purchase the product, and may do so with full vision into the aggregate demand and/or supply of the product on a micro- and macro-scale.

In the above example, the aggregate data is collected from all merchants offering Product 1 for sale within the geographic region (neighborhood in this example) where the mobile device is located. In some embodiments, however, the aggregate data is collected only from certain merchants, for example, only those merchants having a relationship with a financial institution or other entity maintaining the systems discussed herein.

The final step, as represented by block 140, is communicating the offer(s) to the user. The offer(s) may be communicated to the user using the mobile device or some other communication channel, such as via a kiosk at a merchant's location.

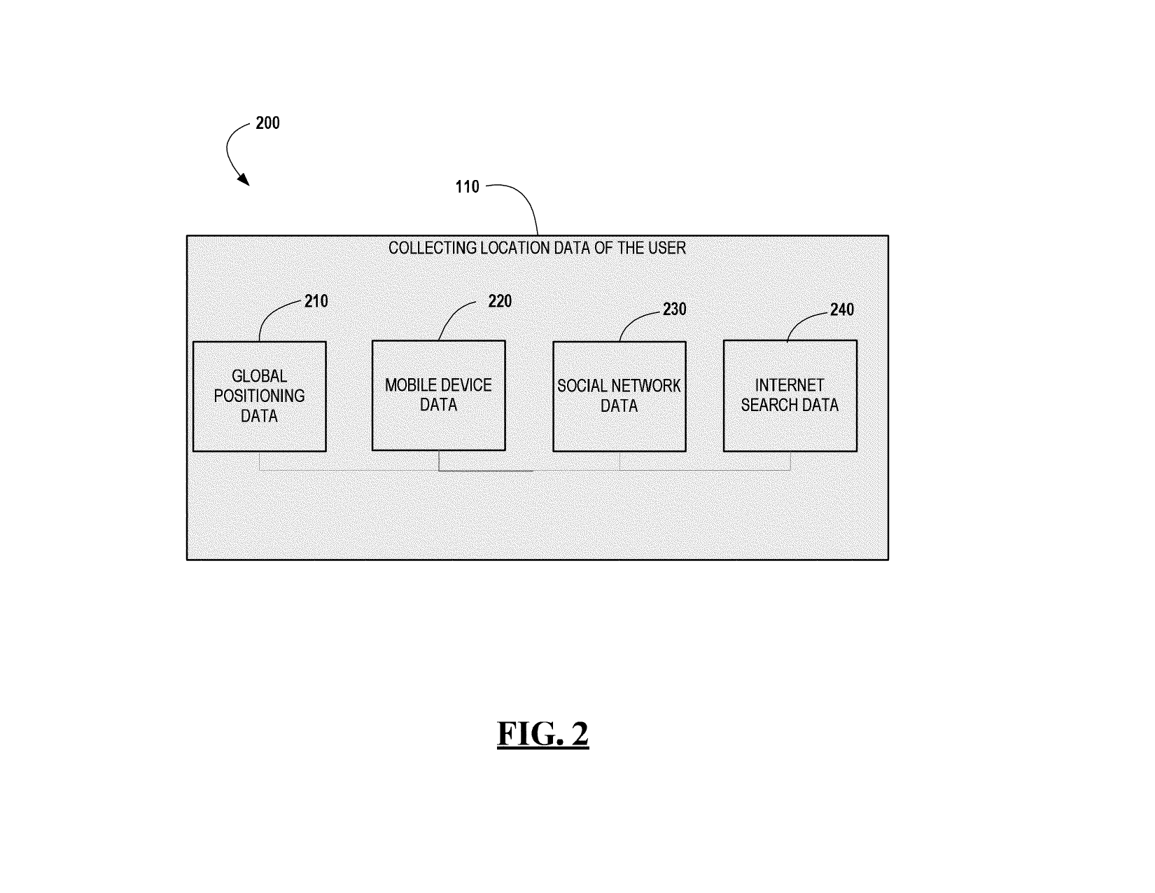

FIG. 2 illustrates details for collecting location data of the user, as represented by block 110 as first presented in FIG. 1. The location data, as illustrated, may include global positioning data 210 of the user, such as location data collected from the user's mobile device. Global positioning data may include any information collected from methods, systems, apparatus, computer programs etc. involving locating a user's position relative to satellites, fixed locations, beacons, transmitters or the like. In some instances, global positioning data may be collected from a GPS device within a mobile device of the user or outside the mobile device of the user, such as a navigation system in another handheld device or in a vehicle. Such a navigation system may be, but is not limited to, hardware and/or software that is part of a mobile phone, smartphone, PDA, automobile, watch etc. or a commercially available personal navigation system or the like. The amount, nature and type of the global positioning data that is collected may depend on the merchant's relationship with the user and the amount of information that the user has authorized the merchant or third-party provider to collect. For instances in some embodiments the global positioning data will be snapshots of the user's location at different times. For example, a snapshot of the user's location may be collected each time the GPS software, navigation system or application is activated. The global positioning data may also include the destination entered by the user, recent searches for locations, attractions, addresses etc. In other instances, the global positioning data may be the complete route being provided to the GPS system's user, including destination, route, alternate routes, anticipated time of arrival etc. In some such embodiments, the global positioning data may include an indication if the user selects a detour from a previously selected route, or instructs the navigation system to reach the desired location taking specific roads or avoiding certain roads. In instances where the user's complete route is provided, additional positioning data may not be necessary to project the route of the user or can be used to confirm the user is traveling on along the suggested route. In this regard, the offer(s) may further be identified based on the user's route of travel or projected route of travel.

As shown in block 220 of FIG. 2, location data of the user may include mobile device data. Mobile device data may include information regarding the location of the user's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data may further include information from an accelerometer that is a part of the mobile device and provides information regarding whether the mobile device is moving, and if so, in what direction. In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and potentially the direction the user is facing and/or traveling.

Referring now to block 230, the location data of the user may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the user's recent, present or future location through expressed data. For instance, a user may upload a blog post, comment on a connection's page, send a friend an electronic message etc. that she is traveling to a specific location or that she is currently in a specific city, or on a specific road etc. Moreover, many already-existing social networks provide users with the ability to “check-in”, “flag” or otherwise indicate the user's current location. Accordingly, user location data collected from social networking data may consist of such indications. Furthermore, many social networks allow users to rate, like, comment etc. on restaurants, attractions, locations and the like. Accordingly, a user may indicate that she ate at a certain restaurant or business at a given time and thereby provide information about her location at that time. Furthermore, a user may upload photographs to a social networking site and thereby provide information about the user's location. In some instances the user's location may be determined from the picture, (for example a picture of a state line sign, a highway sign, a mile marker etc.) or a caption associated with the picture may indicate the user's location and/or the time the photo was taken.

As shown in block 240, the location data of the user may also be collected from Internet data. Internet data, may include any information relating to the searches conducted by the user, websites visited by the user and the like that suggests the user's present or future location(s). For instance, in preparing for a vacation a user may conduct searches for hotels, restaurants or activities in the area where the user will be staying. Similarly, a user may review weather forecasts for locations other than her place of residence indicating that she may soon be traveling to that location. A user may also search for construction or traffic reports indicating future travel along certain roads. Moreover, changes in search patterns may suggest a user's future location. For instance if a user usually uses a web browser application just to read online news articles or to check sports scores but suddenly begins to search for camping gear, hiking manuals and boots it may be indicative that the user is anticipating taking a hiking trip and will be traveling away from her home area. It will be understood that such Internet data may relate to searches or websites visited by the user before she began traveling, however, inasmuch as many mobile devices also include mobile Internet connectivity, it will also be understood that such information may be dynamically collected as the user travels.

In some embodiments, once the location data of the user is collected from one or more of the global positioning data 210, mobile device data 220, social network data 230 and Internet data 240, the location data is analyzed to project the user's likely route of travel. It will be understood that the location data may be data that is available directly to the merchant or data that is collected by other merchants or a third-party service provider and then provided to the merchant. For example, in use, a user in City 1 may engage in a transaction consisting of using a credit card to pay a cab fare. The user's GPS device on her mobile phone, or a phone call placed around the same time, may indicate that she is still in City 1 but a review of her social networking data indicates she has checked-in on her social network page at Airport of City 2. Internet data from the user's mobile phone indicates that she has recently checked the weather a number of times in City 3 (near City 2). Based on this information, a merchant may conclude that the user's is likely traveling by plane from City 1 to City 3 and identify offers for goods or services at either her departing or arriving airport or in City 3.

In some instances in projecting the user's likely route of travel, the projection will be based on the information currently being collected, e.g. the user's current GPS location, the most recent social network and Internet search data etc. In other instances, the current data will be combined with historical positioning data to project the user's likely route of travel. For instance, if historical positioning data indicates that when the user leaves her home traveling south bound and then turns onto a specific highway, ninety percent of the time she is traveling to the beach, this information might be used in the future to project the user's likely route of travel when she begins to follow a similar route. Similarly, the positioning data being currently collected about the user may be combined with information regarding the travel patterns of other users in similar situations to project the user's likely route of travel. For instance, if the user is a young professional of a known income level and the current positioning data indicates that the user is traveling west on an interstate at 5:00 P.M. on a Friday afternoon, this data may be combined with information concerning the travel patterns of other young professionals with similar income levels to identify a likely route of travel.

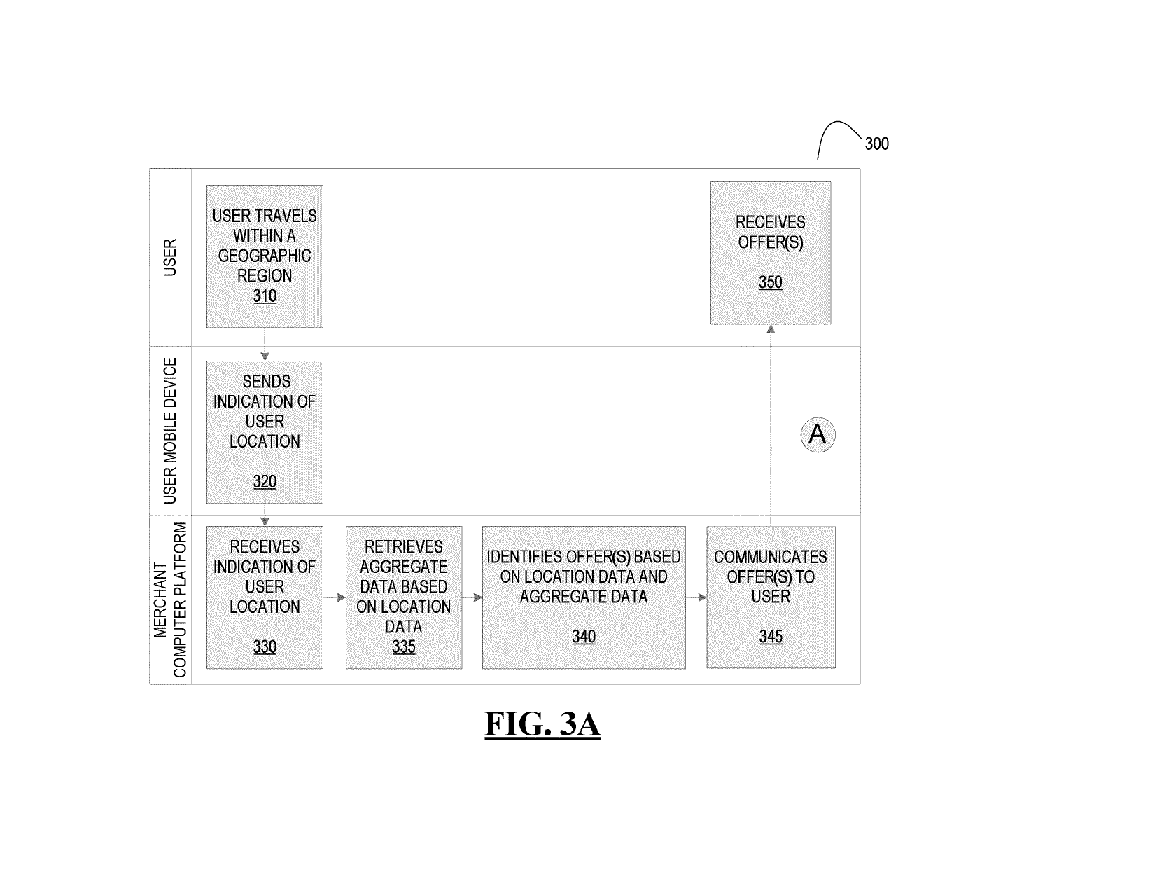

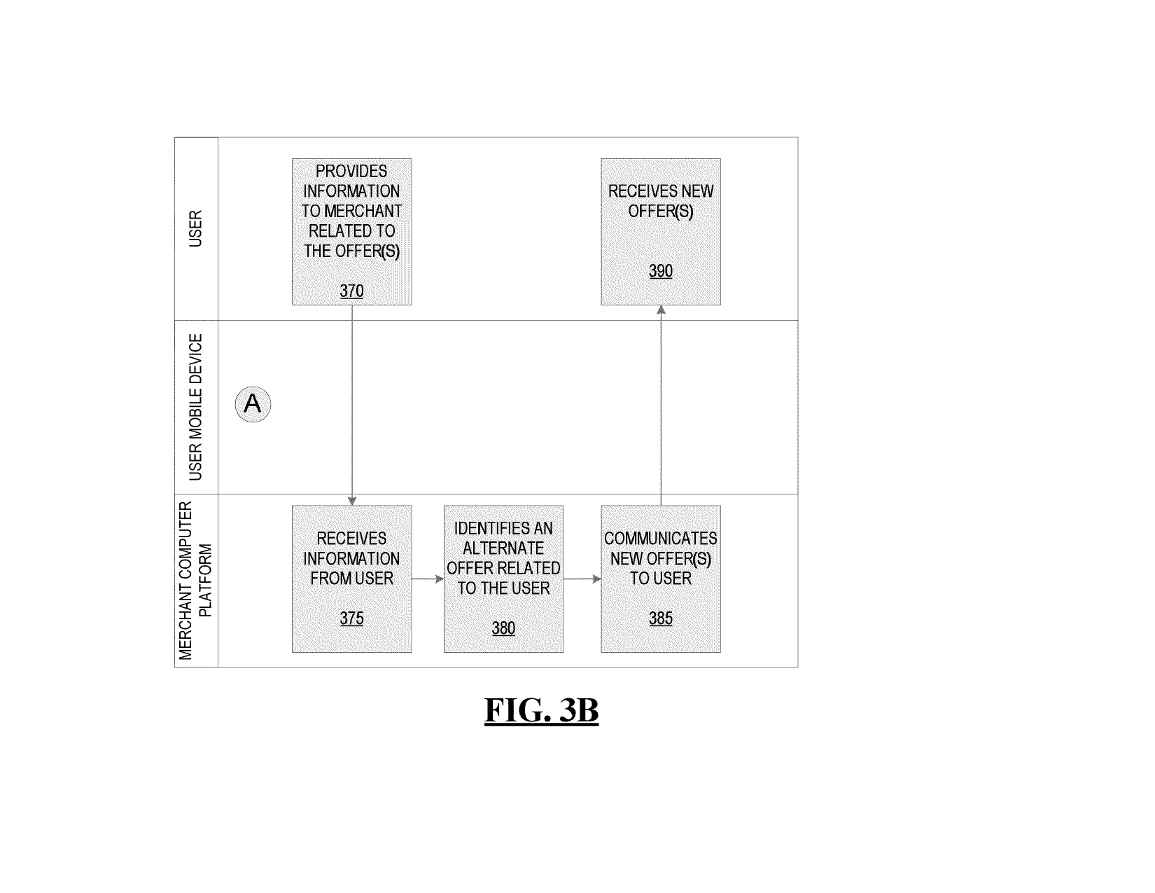

Referring now to FIGS. 3A and 3B, a mixed block and flow diagram illustrates a process flow 300 for communicating offers for goods and services, in accordance with embodiments of the invention. As shown, in some embodiments, steps of the computer-implemented method 300 are performed by the user, a user's mobile device and/or a merchant computer platform. The computer-implemented method 300 allows a merchant to communicate offers for goods or services to a user automatically or to a user that has opted to receive such offers. The merchant collects location data and aggregate data, considers available data concerning the user (in some embodiments), identifies, and then communicates offers based on the location data and, in some embodiments, the aggregate data. Moreover, in some embodiments, as illustrated by FIG. 3B, the user may provide feedback to the merchant regarding the communicated offer and the merchant can identify alternate offers and communicate alternative offers to the user.

In block 310, a user travels within a geographic region. The geographic region may be a predefined geographic region. The user's mobile device sends an indication of the user's location, as represented by block 320 to the merchant computer platform. Next, the merchant computer platform receives the indication of the user's location based on the communication sent from the user's mobile device, as represented by block 330. Then, the merchant computer platform retrieves aggregate data based on the received location data, as represented by block 335. As discussed above, the aggregate data may include one or both of aggregate demand data or aggregate supply data related to at least one product. Next, the merchant computer platform identifies at least one offer based on the location data, and in some embodiments, the aggregate data, as represented by block 340. In alternate embodiments, the offer(s) are identified without taking into account the aggregate data, which is communicated to the user for the user's consideration.

Then, the merchant computer platform communicates the offer(s) to the user, as represented by block 345. This communication may be achieved by any means sufficient to relay the offer from the merchant to the user. In most embodiments, inasmuch as the user is traveling outside of his or her normal area of commercial activity the communication may be made electronically to a mobile device in the user's possession. The communication may be an e-mail, sms message, phone call etc. Moreover, the communication may be a routine or function of an application or computer program on the mobile device and may include an indicator appearing on the display of the mobile device. The communication may also appear as a banner advertisement, pop-up or targeted advertisement within an Internet website accessed by a web browser application on the mobile device. In some embodiments, the communication will include the location and or navigation data necessary for the user to come to the merchant's location to use the offer. In some instances, the communication will push the location and/or navigation data directly to the user's mobile device or navigation system and present the user with the option to navigate to the merchant's location.

The user receives the offer(s), as represented by block 350. The receipt of an offer may include the ability for the user to share the offer with another user. For instance, the offer may enable the user to email the offer to another individual or for the user to provide a name and contact information of another user who may be interested in a similar offer. Similarly, the user may be able to post the offer, or otherwise transmit the offer to friends and family who are connected to the user through a social network. This sharing of the offer may be done manually by the user or may occur automatically based on the user's preferences.

Referring now to FIG. 3B, in certain embodiments, after the user receives an offer from the merchant, as illustrated by block 350 (FIG. 3A) the user may provide information to the merchant responsive to the offer(s). The information may relate to the nature of the offers as illustrated in FIG. 3B or may relate to some other topic such as the user's likely route of travel. In some embodiments, the user's mobile device has projected a likely route of travel for the user based on known data such as location data. For instance, the user may indicate that a projection regarding the likely route of travel is incorrect (e.g. the positioning data was collected from a mobile device that is not currently in the user's possession) and indicate the correct route of travel. Similarly, the user may indicate that she is not interested in offers of the nature communicated by the merchant. The user may also provide information regarding the nature of offers the user has received from other merchants and/or identify specific offers the user would be interested in receiving.

The user may also provide feedback regarding the aggregate data provided to the user. For example, if the aggregate data indicates to the user that the user would be interested in purchasing a particular product, and the offer(s) communicated to the user to this point are not directed to the product, the user may so indicate. Similarly, the aggregate data may have included data regarding a particular product in a particular geographic region, and the user may wish to consider aggregate data for a different product and/or for a different geographic region. For example, if only aggregate demand data is provided for one product for a small geographic region, the user may indicate that the user desires to consider aggregate demand data for alternate products for a large geographic region as well as aggregate supply data. Thus, the user may provide feedback regarding the type of aggregate data provided to the user for his or her consideration. Furthermore, if the aggregate data is used in determining which offer(s) to send the user, the user may provide feedback that the user does not want the aggregate data to be used in identifying offer(s) to be sent to the user. Similarly, the user may provide input prior to receiving initial offer(s), such as in the form of preferences, that the user does or does not want aggregate data, either all aggregate data or some portion of aggregate data, to be used in identifying offer(s) for the user.

In some embodiments the ability to provide information to the merchant is embedded directly in the communication received from the merchant such as a web link or the like. Alternatively, the ability to provide information may be a function of an application of a computer program on the user's mobile device. As represented by block 375 the merchant computer platform receives the information from the user and at block 380, adjusts the projection of the user's likely route of travel (as originally projected from the user's positioning data) and/or the nature of the identified offers based on the information provided by the user. As block 385, the merchant communicates new offers to the user and the user receives the new offers as shown in block 390.

It will be understood that although the above description of process flow 300 describes the steps of the process flow as occurring one after the other, it will be understood that in some embodiments multiple steps will be occurring simultaneously. For instance, the offers being communicated to the user may be constantly updated according to new information collected about the user's position or preferences. By way of example, if the offers being communicated to the user appear as offers displayed on the display of the user's mobile device as a part of an application stored on the mobile device, if the user takes a detour or changes her route of travel, this information may be automatically processed and the offers presented to the user are dynamically updated to reflect offers based on the information provided by the user, such as offers based on newly considered aggregate data.

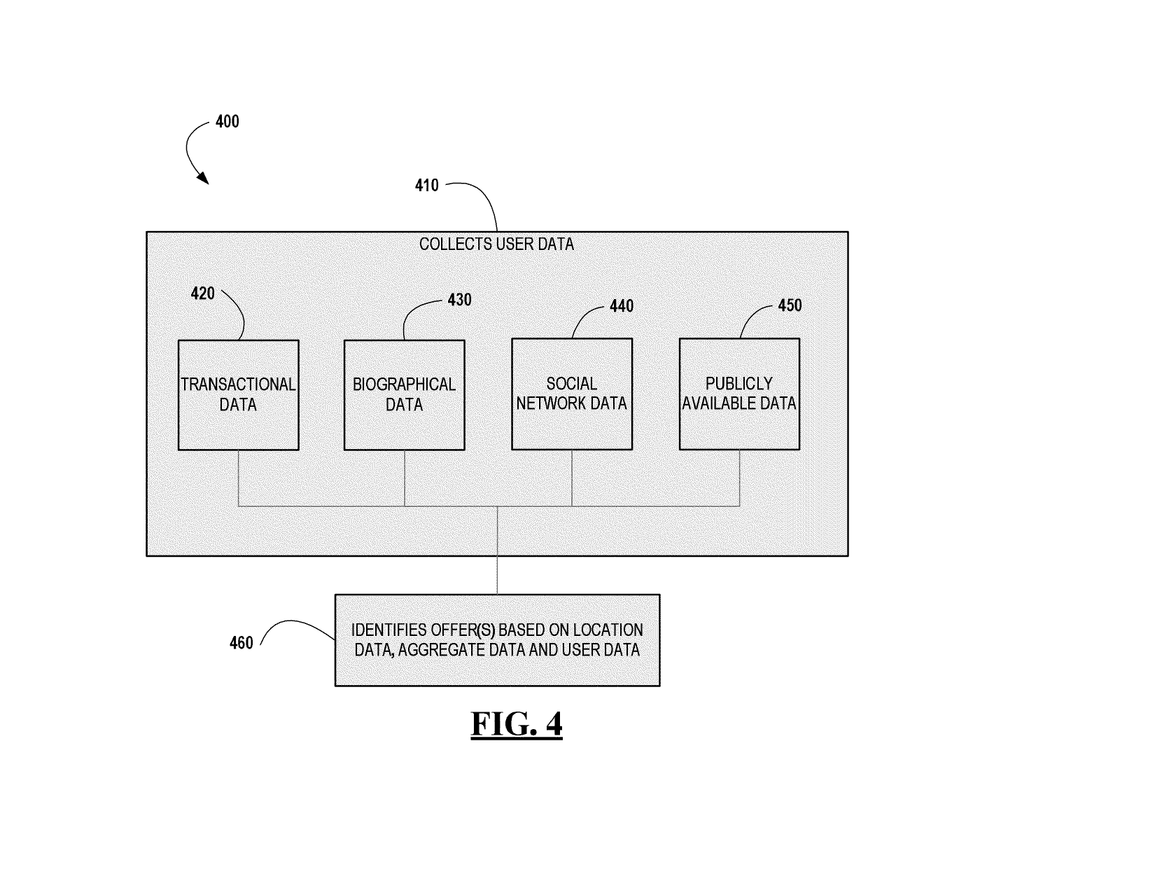

Referring generally to FIG. 4, according to some embodiments of the invention, the mobile device and/or the merchant computer platform collects and/or retrieves user data, in addition to the user location data and the aggregate data. The user data includes information about the user. It will be understood that the term “user data,” as used herein, generally refers to any information that relates to a user and/or the user's purchasing behavior. Such user data may include any information that can be used to determine what goods or services for which the user may be interested in receiving future offers. The merchant computer platform identifies offers in which the user may be interested. This determination, in some embodiments, may be based in part on one or more of aggregate data, an indication of a point-of-transaction event, the user's current position and/or a projected route of travel as determined from the user location data, as well as the collected user data. For instance, if the user location data indicates that the user is likely to travel northbound on a major interstate, the merchant computer platform will correlate this projected path to potential offers for goods and services along the interstate (e.g. discounts on restaurants, buy one get one free admission to an amusement park, promotional rate at a hotel etc.). These offers may be particularly targeted by considering the user data. For instance, if the user data indicates that the user likes a particular type of food, discounts for a restaurant specializing in that type of food near the interstate may be communicated. Similarly, if the user data indicates that the user has children and is likely traveling with her children, the offers may include family deals or goods particularly targeted to the user's children. If an indication of a point-of-transaction event includes information about the transaction, this information can also be used to target the offers to the user. For instance, if the transaction event occurred at 3:00 P.M., the offers may be selected to be relevant for early evening or night purchases (such as dinner or a hotel stay) but exclude offers for breakfast. Similarly, if the transaction event indicates that user purchased gas, drinks and snacks as part of the transaction, the offers to be communicated to the user may avoid offering similar products or may delay the offering of gas, drinks and snacks for a certain period of time until they may be needed again. As another example, the indication of a point-of-transaction event may indicate what day of the week the transaction occurred. Available data may indicate that users are more likely to purchase meals at a sit-down restaurant on Saturdays and Sundays and fast food meals Monday to Friday. Accordingly, if the indication of point-of-transaction event indicates the transaction occurred on a Tuesday, the offers to be communicated to the user might exclude offers for sit-down restaurants or may increase the value of the standard offer for a sit-down restaurant in an effort to overcome the user's normal pattern of behavior.

If the user data includes recent transaction data, the transaction may involve the same merchant that later offers additional goods and services to the user or the merchant may be unrelated to the later merchant. The transaction may occur in a location outside of the user's normal area of commercial activity (e.g. outside of a home city, neighborhood, region etc.). For instance, if the user's commercial activities, such as shopping, eating etc. occur in the downtown area of a city and the transaction event occurs midtown (i.e. a few miles away from downtown), the transaction may trigger offers specific to the geographic area where the user is currently shopping. Similarly, if a user's commercial activities are usually limited to a specific city and the transaction event occurs outside the city, offers may be tailored accordingly. In some embodiments, as the user is conducting a transaction she will be prompted to indicate whether she is willing to receive targeted offers from the merchant or merchants. In other embodiments, the user has preemptively elected to receive such offers. In some embodiments, a point-of-transaction device sends an indication of the transaction event to the merchant computer platform. In some embodiments, the point-of-transaction device will be the same device that facilitated the transaction. In other embodiments, the point-of-transaction device will be one or more servers specifically configured to receive notice of a point-of-transaction event and communicate the same to the merchant computer platform. In certain embodiments, the indication of a point-of-transaction event will include specific information. Such information may include, but is not limited to the time the transaction occurred, the location where the transaction occurred and item level information regarding the goods or services purchased. The merchant computer platform may receive an indication of the point-of-transaction event, which may trigger specific offers. The merchant computer platform may collect user location data and analyze the user location data to project the user's likely route of travel in order to target additional offers, consistent with the embodiments discussed herein.

Referring now specifically to FIG. 4, a process flow 400 for collecting user data and identifying offer(s) based in part on the user data is illustrated in accordance with embodiments of the invention. As illustrated by block 410, user data is collected. The user data may include transactional data as represented by block 420. Transactional data includes, but is not limited to, data regarding the date, location, amount, method of payment etc. of the transactions of the user. The transactional data may be historical transaction data or may be data relating to the transaction that is the subject of the point-of-transaction event. It will be understood that such data may illustrate patterns of purchases that may be predictive of a user's purchasing behaviors. For instance, transactional data may indicate that a user regularly buys coffee from coffee shops. Accordingly, the user may be receptive to offers for discounts to coffee. Moreover, the transactional data may indicate that the user does not generally eat out in restaurants, and consequently, may be more receptive to offers for discounts to a local supermarket then offers relating to a local restaurant. Moreover, transactional data may indicate patterns of behavior relating to where a user shops. For instance, consider a business traveler who drives a certain route along an interstate once every month. According to the available transactional data, the user has stopped at the same gas station every time he has taken the drive. Such information may be useful to a merchant targeting offers to this user. For example, if a competing gas station is interested in capturing the user's business, the size of the offers or discounts it may be required to offer the user to have him change his purchasing routine may be substantial. However, if the merchant is the gas station at which the user already stops, there may be no need to offer discounts in order to attract the user to the gas station and the merchant can consider offers that may entice the user to purchase goods or services beyond what he normally purchases.

As illustrated by block 430, user data may be collected from biographical data. Biographical data includes, but is not limited to, the age, sex, marital status, place of residence, current location, number of children, employment status etc. of a user. Such data may be available to a merchant based on the merchant's prior dealings with the user, through account applications, loyalty programs, and the like. For instance, a financial institution may have access to biographical data from a user's earlier mortgage application. Similarly, a retailer may have access to biographical data from the user's enrollment in the retailer's rewards program. In use, such information may be helpful in targeting offers to a user by limiting offers to those that are generally appropriate for one with similar biographical data. For instance, if a merchant knows through a retail credit card application that the user is nineteen years old and a college student, an offer for a luxury hotel and spa may not be appropriate unless other data indicates the user has significant income. However, an offer for a budget motel, a local night club or pizza restaurant may be appropriate. Similarly, if a merchant has access to data indicating the user has two small children, offers for family friendly events may be more likely to be accepted by the user than offers for events intended for couples only.

As illustrated by block 440, user data may also include social network data. Social network data includes, but is not limited to, postings, comments, profile information, blog entries, micro-blog entries, updates, communications, photos, chat transcripts etc. Such information may directly provide information regarding the user's purchasing preferences. For instances, a user may “like” a certain merchant's social network page or follow a certain merchant's micro-blog feed. Moreover, as discussed above, if a user uses features of social networking sites, such as checking-in, that identify where the user has been, this information may provide further information regarding the businesses that the user frequents. Photos uploaded to social networking sites may similarly illustrate preferences. By way of example, software that includes object recognition may be able to determine the brand names of clothing that the user is wearing and conclude that the user likes these brands. Also, photographs of locations may provide information regarding where the user goes etc.

As shown in block 450, user data may also be collected from publicly available data. While potentially related to social networking data to the extent the publicly available data is found online, this information may also include information that others have written about the user, such as news articles, birth announcements, marriage announcements, job promotions, recordation of deeds or other legal documents, marriage or birth certificates etc. Moreover, such information may include reviews that the user has left regarding goods and services. For instance, if a user reviews a product or service online, this review may be publicly available and may provide insight into the user's purchasing preferences.

As illustrated by block 460, the user data 410 is then considered in combination with the user location data and, in some embodiments, the aggregate data, to identify offer(s) to be communicated to the user. By way of example, consider a user that stops at an ATM to check the balance of her accounts at a location a few hours from her home town. This transaction event triggers the collection of the user's location data. The user's GPS data and phone data indicate that the user is likely traveling along Interstate 75 southbound to Florida. This route correlates to a number of potential offers for hotel and entertainment packages. A review of the user's biographical data 420 indicates that the user has a sister that lives in Florida. Moreover, the transactional data indicates that she has taken a number of trips to Florida in the past twelve months and has never purchased a night in a hotel room. Based on this information, the merchant may conclude to not offer the user hotel services. The user's social network data 430 indicates that the user is traveling to Florida to celebrate her sister's birthday and is looking for ideas to take her sister out to celebrate. Based on this information, the merchant may conclude that the user will be receptive to offers for restaurants in the area where the sister lives and/or entertainment services, e.g. theater or concert tickets, a spa etc. Thus, when the merchant determines to offer the user one or more restaurant offers, the merchant may also communicate aggregate data, such as aggregate data indicating the demand for restaurants of a particular variety in the location where the sister lives. Furthermore, according to some embodiments of the invention, the identification of offer(s) to send the user may be based in part on the aggregate data. For example, the aggregate demand data may indicate that several restaurants of the class typically used for weddings may be in high demand due to the date of the weddings and projections of the probable demand for such restaurants. Similarly, aggregate supply data may be used to confirm that many restaurants are already booked for the dates required. Thus, the offers may be tailored to restaurants of the desired class that are not yet booked. Further, in addition to being used to identify the appropriate offer(s), some or all the aggregate data may be communicated to the user for her consideration. As another example, the aggregate data may also include macro-data related to the types of restaurants in demand for wedding parties and/or macro-data related to the supply of the types of restaurants on typical wedding nights. The supply macro-data may, in some embodiments, may be based on days prior to the event. For example, the supply of reservations at a restaurant may diminish as the event approaches.

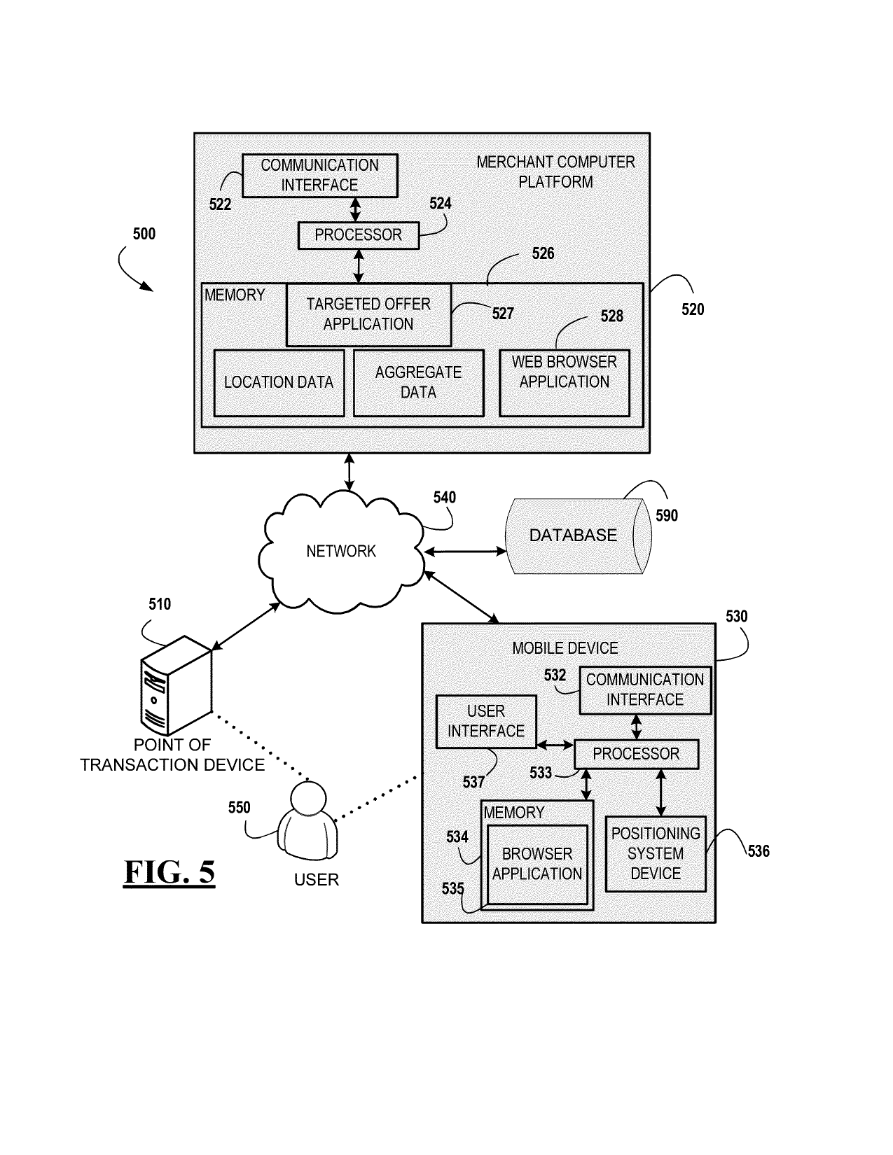

FIG. 5 provides a block diagram illustrating an environment 500 in which a merchant computer platform 520 for communicating offers for goods and services operates, in accordance with embodiments of the invention. A point-of-transaction device 510, a merchant computer platform 520, a mobile device 530, a network 540 and a user 550 may interact with one another as illustrated. It will be understood that the user 550 has access to the mobile device 530.

In some embodiments, the point-of-transaction device 510 may be operatively and selectively linked to the merchant computer platform 520 over the network 510. As illustrated, some embodiments of the merchant computer platform 520 may include a targeted offer application 527 configured to receive user location information, retrieve aggregate data, and, in some embodiments, collect user data from the mobile device 530, the point-of-transaction device 510, and/or some other device or devices not shown.

As shown in FIG. 5, the point-of-transaction device 510, merchant computer platform 520 and mobile device 530 are each operatively and selectively connected to the network 540, which may include one or more separate networks. In addition, the network 540 may include a local area network (LAN), a wide area network (WAN), and/or a global area network (GAN), such as the Internet. It will also be understood that the network 540 may be secure and/or unsecure and may also include wireless and/or wireline technology.

The mobile device 530 may include any computerized apparatus that can be configured to perform any one or more of the functions of the mobile device 530 described and/or contemplated herein. As shown in FIG. 5, in accordance with some embodiments of the present invention, the mobile device 530 includes a communication interface 532, a processor 533, a memory 534 having a browser application 535 stored therein, a positioning system device 536, such as a GPS device, and a user interface 537. In such embodiments, the communication interface 532 is operatively and selectively connected to the processor 534, which is operatively and selectively connected to the user interface 537, the memory 534 and the positioning system device 536. In some embodiments, the memory 534 of the mobile device 530 includes a targeted offer application, similar or identical to the targeted offer application 527 stored in memory 526 of the merchant computer platform 520. In this regard, the targeted offer applications are configured to communicate with one another using their associated devices and are configured to perform one or more of the steps of the various methods disclosed herein.

The user interface 538, which may allow the mobile device 530 to receive data from the user 550, may include any of a number of devices allowing the mobile device 530 to receive data from the user 550, such as a keypad, keyboard, touch-screen, touchpad, microphone, mouse, joystick, stylus, other pointer device, button, soft key, and/or other input device(s). In some embodiments, the user interface 538 also includes one or more user output devices, such as a display and/or speaker, for presenting information to the user 550.

Each communication interface described herein, including the communication interface 532 and 522, generally includes hardware, and, in some instances, software, that enables a portion of the one or more of the devices discussed herein, such as the processor 533 to transport, send, receive, and/or otherwise communicate information. For example, the communication interface 532 of the mobile device 530 may include a modem, server, electrical connection, and/or other electronic device that operatively connects the mobile device 530 to another electronic device, such as the electronic devices that make up the merchant computer platform 520.

Each processor described herein, including the processor 533 and 524, generally includes circuitry for implementing the audio, visual, and/or logic functions of that portion of the system 500. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as the memory 534 of the mobile device 530 and the memory 526 of the merchant computer platform 526.

Each memory device described herein, including the memory 536 for storing the browser application 535 and other data and/or programs, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 534 includes a browser application 535. The browser application 535 may be used by the user 550 to conduct Internet searches and/or access online social networks over the network 540. In some embodiments, the browser application 535 includes computer-executable program code portions for instructing the processor 534 to perform one or more of the functions of the browser application 535 described and/or contemplated herein. In some embodiments, the browser application may be configured to a collect and transmit through the communication interface data collected from the Internet searches conducted by the user 550 and/or the social network data accessed using the mobile device 530. In some embodiments, the browser application 535 may include and/or use one or more network and/or system communication protocols.

It will be understood that the mobile device 530 can be configured to implement one or more portions of the process flows described and/or contemplated herein. For example, in some embodiments, the user interface apparatus 530 is configured so that the communication interface 532 is operatively linked to the merchant computer platform 520 to provide location data of the user 550. For instance, the positioning system device 536 and/or the browser application 535 may provide global positioning data 210, social networking data 230 and/or Internet search data 230 to the merchant computer platform to be processed. The processor 533 or some other apparatus of the mobile device 530 may be configured to collect and transmit the location data 110 to the merchant computer platform 520. Similarly, the mobile device 530 may be used to collect and provide some, or all, of the user data 410 discussed in process flow 400 of FIG. 4.

FIG. 5 also illustrates a merchant computer platform 520, in accordance with embodiments of the invention. The merchant computer platform 520 may include any computerized apparatus that can be configured to perform any one or more of the functions of the merchant computer platform 520 described and/or contemplated herein and may be two or more computer components, systems, servers or the like communicating and working in conjunction with one another. In accordance with some embodiments, for example, the merchant computer platform 520 may include one or more of an engine, a platform, a server, a database system, a front end system, a back end system, a personal computer system, multiple components or systems and/or the like. In some embodiments, such as the one illustrated in FIG. 5, the merchant computer platform 520 includes a communication interface 522, a processor 524 and a memory 526. In some embodiments, as illustrated in FIG. 5, a targeted offer application 527 and web browser application 528 may be stored in memory 526. Moreover, in certain embodiments the location data and user data collected in accordance with the process flows described and/or contemplated herein may be stored in memory 526 for access by the processor 524. The communication interface 522 is operatively and selectively connected to the processor 524, which is operatively and selectively connected to the memory 526. In some embodiments, some or all the data collected, stored and/or retrieved may be stored and/or retrieved in database 590, which may represent one or more databases, datastores or other memory devices separate from the merchant computer platform 520 and the mobile device 530.

In some embodiments, the processor 524 (and/or the processor 533) may also be capable of operating one or more applications, such as one or more applications functioning as an artificial intelligence (“AI”) engine. The processor 524 may recognize, by way of the AI engine, aggregate demand data, aggregate supply data, projected travel routes, product or service offers etc. that it has previously communicated to the user as well as the user's response to the communicated offers (e.g. whether the offer was accepted, rejected or the user provide additional information etc.). In this way, the processor may recognize the aggregate data, routes, offers and the like and store information related to the aggregate data, routes, offers etc. in one or more memories discussed herein, such as memory 526. Once the AI engine has thereby “learned” of common requests for aggregate data, routes, offers and the user's response to such offers, the AI engine may run concurrently with and/or collaborate with other modules or applications described herein to perform the various steps of the methods discussed. For example, in some embodiments, the AI engine recognizes an offer that appears correlated to the user's projected travel route and user data but that the user has routinely rejected in the past. The AI engine may then communicate to another application or module of the merchant computer platform 520, an indication that an alternate offer should be identified, perhaps using aggregate demand and/or supply data to support the new offer(s). In this regard, the AI engine may provide a baseline or starting point from which to determine offers of goods or services to be communicated to the user.

As shown in FIG. 5, the memory 526 includes a browser application 528. The browser application 528 may be used by the merchant computer platform 520 to conduct Internet searches for publicly available data and/or access online social networks over the network 540 consistent with the process flows discussed herein in connection with collecting user data. In some embodiments, the browser application 528 includes computer-executable program code portions for instructing the processor 524 to perform one or more of the functions of the browser application 528 described and/or contemplated herein. In some embodiments, the browser application 528 may include and/or use one or more network and/or system communication protocols.

It will be understood that the merchant computer platform 520 can be configured to implement one or more portions of the process flows described and/or contemplated herein. For example, in some embodiments, the merchant computer platform 520 is configured so that the communication interface 522 is communicatively linked to the mobile device 530 to collect the location data (block 110 of FIG. 1) and/or user data (block 410 of FIG. 4). In certain embodiments the web browser application 528, stored in the memory 526 of the merchant computer platform 520 is configured to operatively link to the network 540 through the communication interface 522 to collect user data. In some embodiments, targeted offer application 527 stored in the memory 526 of the merchant computer platform 520 is configured to receive an indication of a point-of-transaction event from the point-of-transaction device 510 and the processor 524 is configured to use the indication of the point-of-transaction event along with the aggregate data, location data and user data to identify. In some embodiments, the targeted offer application 527 is configured to receive location data, determine appropriate parameters for aggregate data necessary to identify appropriate offer(s), and retrieves the appropriate aggregate data from the database 590 or other system. In some embodiments, the targeted offer application 527 also considers aggregate data that may be useful to the user in determining whether to purchase a product or whether to accept one or more offers. Thus, the targeted offer application 527 may retrieve such aggregate data in order to communicate the aggregate data to the user for his or her consideration. Consistent with certain embodiments, the merchant computer platform 520 is configured to communicate offers to the user 550. In some embodiments, the communication of offers will be facilitated by the communication interface 522 communicatively linking over the network 540 with the mobile device 530 to transmit the offer. Similarly, in certain embodiments, the communication interface 522 will be configured to receive information from the user 550 relative to the projected likely route of travel or the offer(s) communicated to the user 550.

It will be understood that the embodiment illustrated in FIG. 5 is exemplary and that other embodiments may vary. For example, in some embodiments, some of the portions of the components and devices in environment 500 may be combined into a single portion. Specifically, in some embodiments, the merchant computer platform 520 is configured to perform some of the same functions of those separate portions as described and/or contemplated herein. Likewise, in some embodiments, some or all of the portions of the components, systems and/or devices in environment 500 may be separated into two or more distinct portions.

In various embodiments discussed herein, the aggregate demand data may be supplied to the merchant and/or a retailer, while the aggregate supply data is supplied to both the merchant and the user or customer. In this regard, the aggregate demand data may be used by the merchant as an effective means to push offers as necessary to meet demand. Furthermore, the aggregate supply data may be beneficial for the user to gauge whether a supply may be likely to run out in the near future so that a purchase decision may be made quickly. Alternatively, in other embodiments, both the aggregate demand data and the aggregate supply data may be provided to both the merchant(s) and the user(s) or one or both may be withheld from either the merchant(s) or the user(s) or both for a variety of reasons. For example, a third party, such as a potential investor in the merchant's business may be interested in analyzing the aggregate data as it relates to potential customers entering a specific geographic region. In this regard, the merchant may never have access to the aggregate data, but rather the third party may communicate directly with the user and/or the user's mobile device.

In various embodiments discussed herein, during pre-release of a product, a market may be created based on aggregate demand data and/or aggregate supply data. In this regard, a sub-set of existing and/or potential customers may be created and targeted by one or more offers.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive of the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for communicating at least one offer for a product offered by a merchant, the method comprising:
collecting location data, wherein the location data comprises information related to a physical location of a user;
retrieving, based at least in part on the collected location data, aggregate data related to the product, the aggregate data comprising at least one of aggregate demand data or aggregate supply data;
identifying at least one offer related to the product based at least in part on the collected location data and the retrieved aggregate data; and
communicating the offer to the user.

2. The method of claim 1, further comprising:
collecting user data, wherein the user data comprises information about the user; and
identifying one or more offers that relate to the product is further based at least in part on the user data.

3. The method of claim 1, wherein the location data is collected from at least one of global positioning data, transaction data, mobile device data, social networking data or search data.

4. The method of claim 2, wherein the user data is collected from at least one of transactional data, biographical data, social network data or publicly available data.

5. The method of claim 1, wherein the offer is selected from discounts for goods or services offered by the merchant, discounts for goods or services offered by other merchants, access to goods or services otherwise unavailable to the user, or reductions in fees.

6. The method of claim 1, further comprising:
receiving information from the user relative to an intended route of travel;
determining a projection of the user's likely route of travel, based in part on the information received from the user; and
communicating alternative offers to the user based on the projection of the user's likely route of travel.

7. The method of claim 1, further comprising:
receiving information from the user related to the communicated offer;
identifying at least one alternate offer that relates to the user, based at least in part on the information from the user; and
communicating at least one alternate offer to the user.

8. The method of claim 1, wherein the aggregate data comprises aggregate demand data related to an aggregate demand of the product.

9. The method of claim 8, wherein the aggregate demand data comprises data indicating a demand for the product across a predetermined geographic territory.

10. The method of claim 8, wherein the aggregate demand data comprises data indicating a demand for the product higher than a predetermined threshold, and wherein identifying an offer for the product is based at least in part on the demand for the product being higher than the predetermined threshold.

11. The method of claim 8, wherein the aggregate demand data comprises data indicating a demand for the product lower than a predetermined threshold, and wherein identifying an offer for the product is based at least in part on the demand for the product being lower than the predetermined threshold.

12. The method of claim 1, wherein the aggregate data comprises aggregate supply data related to an aggregate supply of the product.

13. The method of claim 12, wherein the aggregate supply data comprises data indicating a supply of the product across a predetermined geographic territory.

14. The method of claim 12, wherein the aggregate supply data comprises data indicating a supply of the product higher than a predetermined threshold, and wherein identifying an offer for the product is based at least in part on the supply of the product being higher than the predetermined threshold.

15. The method of claim 12, wherein the aggregate supply data comprises data indicating a supply of the product lower than a predetermined threshold, and wherein identifying an offer for the product is based at least in part on the supply for the product being lower than the predetermined threshold.

16. An apparatus comprising:
a computing platform comprising a memory and at least one processor operatively connected with the memory, wherein the processor is configured to:
collect location data, wherein the location data comprises information related to a physical location of a user;
retrieve, based at least in part on the collected location data, aggregate data related to the product, the aggregate data comprising at least one of aggregate demand data or aggregate supply data;
identify at least one offer related to the product based at least in part on the collected location data and the retrieved aggregate data; and
communicate the offer to the user.

17. The apparatus of claim 16, wherein the processor is further configured to:
collect user data, wherein the user data comprises information about the user; and
identify one or more offers that relate to the product is further based at least in part on the user data.

18. The apparatus of claim 16, wherein the location data is collected from at least one of global positioning data, transaction data, mobile device data, social networking data or search data.

19. The apparatus of claim 17, wherein the user data is collected from at least one of transactional data, biographical data, social network data or publicly available data.

20. The apparatus of claim 16, wherein the offer is selected from discounts for goods or services offered by the merchant, discounts for goods or services offered by at least one other merchant, access to goods or services otherwise unavailable to the user, or at least one reduction in fees.

21. The apparatus of claim 16, wherein the processor is further configured to:
receive information from the user relative to an intended route of travel;
determine a projection of the user's likely route of travel, based in part on the information received from the user; and
communicate alternative offers to the user based on the projection of the user's likely route of travel.

22. The apparatus of claim 16, wherein the processor is further configured to:
receive information from the user related to the communicated offer;
identify at least one alternate offer that relates to the user, based at least in part on the information from the user; and
communicate at least one alternate offer to the user.

23. The apparatus of claim 16, wherein the aggregate data comprises aggregate demand data related to an aggregate demand of the product.

24. The apparatus of claim 23, wherein the aggregate demand data comprises data indicating a demand for the product across a predetermined geographic territory.

25. The apparatus of claim 23, wherein the aggregate demand data comprises data indicating a demand for the product higher than a predetermined threshold, and wherein identifying an offer for the product is based at least in part on the demand for the product being higher than the predetermined threshold.

26. The apparatus of claim 23, wherein the aggregate demand data comprises data indicating a demand for the product lower than a predetermined threshold, and wherein identifying an offer for the product is based at least in part on the demand for the product being lower than the predetermined threshold.

27. The apparatus of claim 16, wherein the aggregate data comprises aggregate supply data related to an aggregate supply of the product.

28. The apparatus of claim 27, wherein the aggregate supply data comprises data indicating a supply of the product across a predetermined geographic territory.

29. The apparatus of claim 27, wherein the aggregate supply data comprises data indicating a supply of the product higher than a predetermined threshold, and wherein identifying an offer for the product is based at least in part on the supply of the product being higher than the predetermined threshold.

30. The apparatus of claim 27, wherein the aggregate supply data comprises data indicating a supply of the product lower than a predetermined threshold, and wherein identifying an offer for the product is based at least in part on the supply for the product being lower than the predetermined threshold.

31. A computer program product comprising a non-transitory computer-readable medium having computer-executable instructions stored thereon, the computer-executable instructions comprising instructions to:
collect location data, wherein the location data comprises information related to a physical location of a user;
retrieve, based at least in part on the collected location data, aggregate data related to the product, the aggregate data comprising at least one of aggregate demand data or aggregate supply data;
identify at least one offer related to the product based at least in part on the collected location data and the retrieved aggregate data; and
communicate the offer to the user.

32. The computer program product of claim 31, wherein the instructions further comprise instructions to:
collect user data, wherein the user data comprises information about the user; and
identify one or more offers that relate to the product is further based at least in part on the user data.

33. The computer program product of claim 31, wherein the location data is collected from at least one of global positioning data, transaction data, mobile device data, social networking data or search data.

34. The computer program product of claim 32, wherein the user data is collected from at least one of transactional data, biographical data, social network data or publicly available data.

35. The computer program product of claim 31, wherein the offer is selected from discounts for goods or services offered by the merchant, discounts for goods or services offered by at least one other merchant, access to goods or services otherwise unavailable to the user, or at least one reduction in fees.

36. The computer program product of claim 31, wherein the instructions further comprise instructions to:
receive information from the user relative to an intended route of travel;
determine a projection of the user's likely route of travel, based in part on the information received from the user; and
communicate alternative offers to the user based on the projection of the user's likely route of travel.

37. The computer program product of claim 31, wherein the instructions further comprise instructions to:
receive information from the user related to the communicated offer;
identify at least one alternate offer that relates to the user, based at least in part on the information from the user; and
communicate at least one alternate offer to the user.

38. The computer program product of claim 31, wherein the aggregate data comprises aggregate demand data related to an aggregate demand of the product.

39. The computer program product of claim 38, wherein the aggregate demand data comprises data indicating a demand for the product across a predetermined geographic territory.

40. The computer program product of claim 38, wherein the aggregate demand data comprises data indicating a demand for the product higher than a predetermined threshold, and wherein identifying an offer for the product is based at least in part on the demand for the product being higher than the predetermined threshold.

41. The computer program product of claim 38, wherein the aggregate demand data comprises data indicating a demand for the product lower than a predetermined threshold, and wherein identifying an offer for the product is based at least in part on the demand for the product being lower than the predetermined threshold.

42. The computer program product of claim 31, wherein the aggregate data comprises aggregate supply data related to an aggregate supply of the product.

43. The computer program product of claim 42, wherein the aggregate supply data comprises data indicating a supply of the product across a predetermined geographic territory.

44. The computer program product of claim 42, wherein the aggregate supply data comprises data indicating a supply of the product higher than a predetermined threshold, and wherein identifying an offer for the product is based at least in part on the supply of the product being higher than the predetermined threshold.

45. The computer program product of claim 42, wherein the aggregate supply data comprises data indicating a supply of the product lower than a predetermined threshold, and wherein identifying an offer for the product is based at least in part on the supply for the product being lower than the predetermined threshold.
